(19) United States
(12) Patent Application Publication
(10) Pub. No.: US 2009/0301736 A1
(43) Pub. Date: Dec. 10, 2009

(54) Deployable exterior fire protection system

(76) Inventor: Craig I. TIECK, Ramona, CA (US)

Correspondence Address: THE NATH LAW GROUP, 112 South West Street, Alexandria, VA, 22314, US

(21) Appl. No.: 12/155,563

(22) Filed: Jun. 5, 2008

(51) Int. Cl. A62C 35/58

(52) U.S. Cl. 169/16

(57) ABSTRACT

An exterior fire protection system may be stored, and is readily deployable with respect to at least one selected side of a structure. A portable water line may be releasably secured adjacent a respective selected side of a structure. At least one sprayer is connected to the water line and positioned to provide a spray over a preselected area. The water line has a portion for coupling to a water source. The water line may comprise a first sprayer and a second sprayer positioned to spray under eaves and on a roof respectively. Each water line may be vertically disposed and may also be coded with indicia to indicate association with a particular structure wall to which the water line is proportioned. A system including a pump and a generator may also be provided.

### BACKGROUND OF THE INVENTION

1. Field of the Invention

The present subject matter relates generally to systems for protecting a structure from ignition due to approaching fires.

2. Related Art

Exterior fire protection systems are used to prevent ignition of structures when the structures are approached by flames, embers, or heat radiated by fires. A common element of prior art fire protection systems is a sprinkler array which can soak or otherwise keep structure elements such as roofs and walls below ignition temperature. Many such systems comprise permanently installed plumbing components. Such systems may be too expensive to include in new construction and may be impracticable to retrofit into older construction.

Additionally, many prior art systems take a “one-size-fits-all” approach. More specifically, systems are designed to cover an entire structure. This approach evenly divides water resource allocations around a structure without regard to the type of danger. This approach may be preferred when used in a house endangered by a forest fire in Colorado. However, in other contexts, approaches of fires may be highly directional. A significant class of wildfires is encountered in Southern California during autumnal dry seasons. Santa Ana winds occur seasonally coinciding with dry climatic conditions. These winds blow from east to west. Dry brush provides abundant fuel. Wildfires that may be initiated by any number of causes are fanned by the Santa Ana winds and are also driven from wild areas to populated areas. Sustained winds are produced which can reach 70 mph. The winds are of sufficient velocity and turbulence to render the use of firefighting rotary wing and fixed wing aircraft tankers impracticable for days at a time. In these situations, a fire does not surround a house, but approaches from one direction usually facing one or two sides of a house. Fire protection may be maximized by allocating available water resources to one or two sides of a structure while not cooling other sides of a structure. As the fire progresses, it will pass the structure, and will continue away from the structure blown by the wind. Resources expended on protecting sides of the structure which do not face the approaching fire are not only substantially wasted; they divert available resources which could otherwise protect endangered sides of the structure.

In Southern California, many homes have ceramic tile roofs. Homeowners with ceramic tile roofs may have a false sense of security. Tile will prevent ignition from landing embers, but will not prevent heat buildup under eaves. As heat rises, intense temperatures can be reached under eaves and cause ignition even in the absence of flames. These temperatures can be in the range of 700°-800° F.

Some prior art systems do not provide cooling under eaves. For example, U.S. Pat. No. 6,360,968 discloses a system including rotating sprinklers positioned on the roof of a house. U.S. Pat. No. 6,772,562 discloses a building perimeter fire suppression system in which a plurality of water outlets are spaced along a perimeter of a roof and are also used to wet areas on grounds of a house. This system does not wet the walls of a house, nor does it provide cooling under the eaves.

U.S. Pat. No. 5,083,618 discloses a fire control system for buildings, wherein the building is provided with a sprinkler system around the perimeter of the building. The system has a first sprinkler which sprays water on a roof and a second sprinkler which sprays water inwardly toward a building below roof level. The system requires installation of a conduit around a perimeter of a structure. The sprinklers are fixed in position and connected to permanently installed plumbing.

U.S. Pat. No. 5,931,233 discloses a fire suppression/protection system which first employs a set of fog jet nozzles activated by microphone sensors to atomize water under high pressure to produce a cool fog dispersion pattern surrounding the structure. A second set of spiral jet nozzles which are operated in response to a heat sensor or other sensor is intended to create a dispersion that deluges the entire surface area of the structure with water. The fog pattern may not be achievable in the presence of high winds. Coverage of all areas rather than selected areas is required.

Other schemes have been provided for protecting structures from approaching fires which are impractical for use with occupied structures. The schemes include the use of covers to enclose a structure or cover portions of the structure. For example, United States Patent Application Publication Number 2005/0170725 discloses a protective barrier blanket to be mounted to a house. United States Patent Application Publication Number 2006/0277830 discloses a pliable multilayered shroud of fire-resistant material having an inflatable support structure embedded therein to completely enclose a house.

United States Patent Application Publication Number 2006/0113403 discloses a fire retardant distribution system designed for use with various types of structures, such as residences, outbuildings and others. The system relies upon a spray system that when activated coats the exterior of the structures, decks and surrounding landscape very rapidly with a liquid, decolorized fire retardant that remains on the surface until washed off. The system is self-contained and relies upon tanks pressurized with inert gas to deliver the fire retardant to spray valves positioned on and around the structures and surrounding areas. In an alternate embodiment, compressed gas-powered pumps deliver fire retardant to desired areas to flank a wildfire and control its direction and behavior. This system requires a relatively complex permanent installation including electronic controls and an inert gas supply system.

### SUMMARY OF THE INVENTION

Embodiments of the present subject matter are directed to a deployable exterior fire protection system. The system comprises components which may be stored, and is readily deployable when needed. The system is used with respect to one or more selected sides of a structure. For example, if only two sides are threatened by fire, components need only be deployed with respect to two sides. A water line is releasably or otherwise secured adjacent a respective selected side of a structure. At least one sprayer is connected to the water line and is positioned to provide a spray over a preselected area. The water line has a portion for coupling to a water source. The water line may comprise a first sprayer to spray under eaves and a second sprayer positioned to spray a roof. Each water line may be vertically disposed and may also be coded with indicia to indicate association with a particular structure wall to which the water line is proportioned. A system including a pump and a generator may also be provided.

### BRIEF DESCRIPTION OF THE DRAWINGS

Embodiments of the subject matter are more particularly described with reference to the following drawings taken in connection with the following description.

FIG. 1 is a plan view of a structure threatened by an approaching fire;

FIG. 2 a perspective illustration of the structure of FIG. 1;

FIG. 3 is an elevation of one side of the structure of FIG. 1;

FIG. 4 is a side view of the elevation of FIG. 2;

FIGS. 5 and 6 are partial detailed views of a water line;

FIG. 7 is an elevation and FIG. 8 is a plan view of releasable securing means to maintain a water line adjacent to a side of a structure;

FIG. 9 is an illustration of the components of the releasable securing means in a detached state;

FIGS. 10 and 11 are respectively a front elevation and a side elevation of a second water line; and

FIG. 12 is a plan view of side sprayer;

FIG. 13 is a perspective view of a top sprayer; and

FIG. 14 is a plan view of a further embodiment.

### DETAILED DESCRIPTION

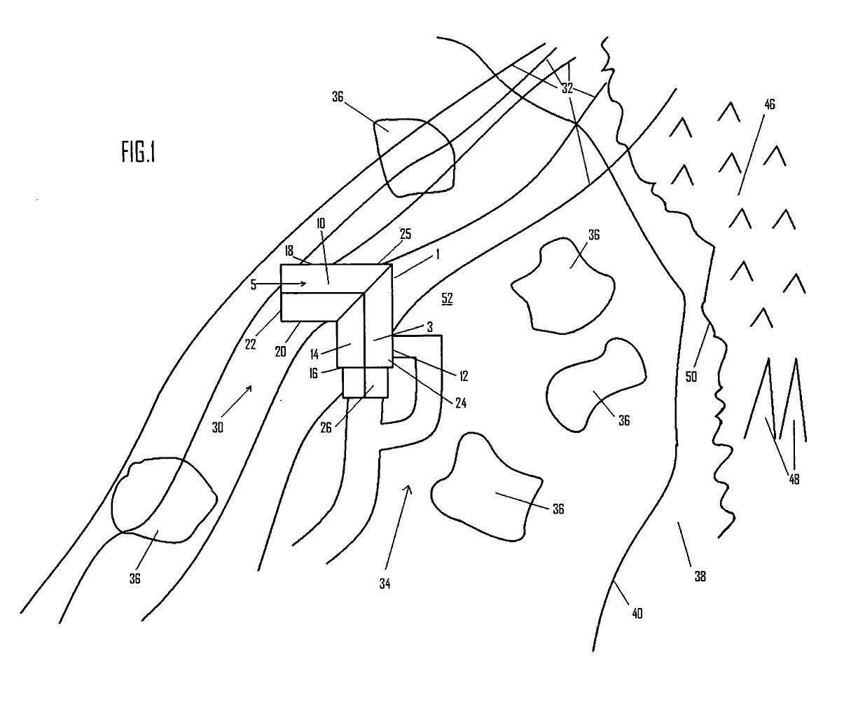

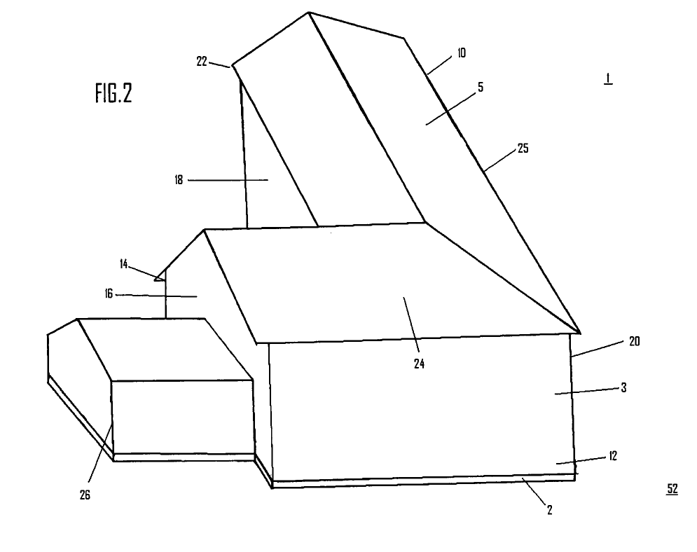

A first embodiment of the present subject matter is described with respect to FIGS. 1 and 2. A system comprising an embodiment according to the present subject matter may protect a structure such as a house 1. Structures could comprise residences or outbuildings, temporary or permanent buildings, commercial structures or other forms of real property improvements.

In the present illustration, various parameters of the house 1, its physical surroundings and the type of fire by which it is threatened are described. However, embodiments of the present subject matter are not limited to use in the present context. The house 1, which is on a foundation 2 (FIG. 2) comprises an ell having a first wing 3 and a second wing 5. This configuration is selected for purposes of illustration, and the present subject matter is not limited to any particular shape of house. The house 1 is covered by a roof 10. The first wing 3 has first and second parallel walls 12 and 14. A first end wall 16 forms an end of the first wing 3 remote from the second wing 5. The second wing 5 may be perpendicular to the first wing 3. The second wing 5 comprises third and fourth parallel walls 18 and 20. A second end wall 22 forms an end of the second wing 5 remote from the first wing 3. The first and second wings 3 and 5 join to form a corner portion of an L shape. The first wing 3 may have a garage 26 projecting therefrom and adjoining the first end wall 16. The first wall eave 24 and third wall eave 25 respectively overhang the first and third walls 12 and 18.

The house 1 is situated on a hill 30. Grade lines 32 illustrate the slope of the hill 30. Due to the slope of the hill, the first wall 12 is one story high, while the third wall 18 is two stories high. The house 1 is located on a cleared lot 34. Ornamental trees 36 are located on the lot 34. The lot 34 is located among a wooded area 38. A boundary line 40 provides an approximate demarcation between the lot 34 and the wooded area 38. In the present illustration, the house 1 is threatened by a fire 46 characterized by a body of flames 48 having a front 50. In the present illustration, the fire 46 is approaching the house 1 driven by easterly winds, i.e., winds blowing in from east to west, as is commonly the case in California wildfires. The threats to ignition of the house 1 include embers blowing from the fire 46, heat radiating from the fire 46, and the flames 48. When a fire threat is sensed, a user 52 may deploy apparatus in accordance with embodiments of the present subject matter. The user 52 may be a homeowner, custodian or another individual or a plurality of individuals.

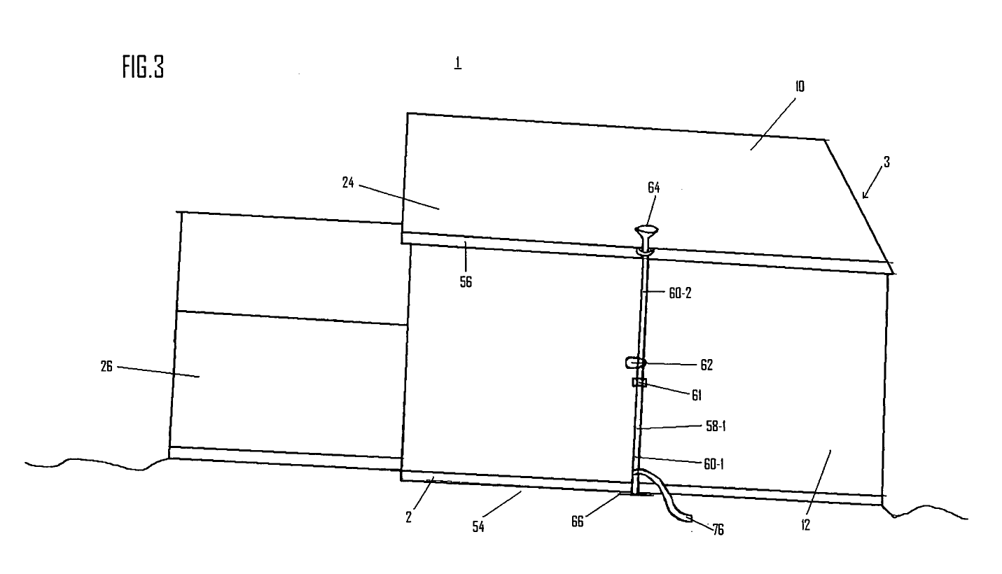

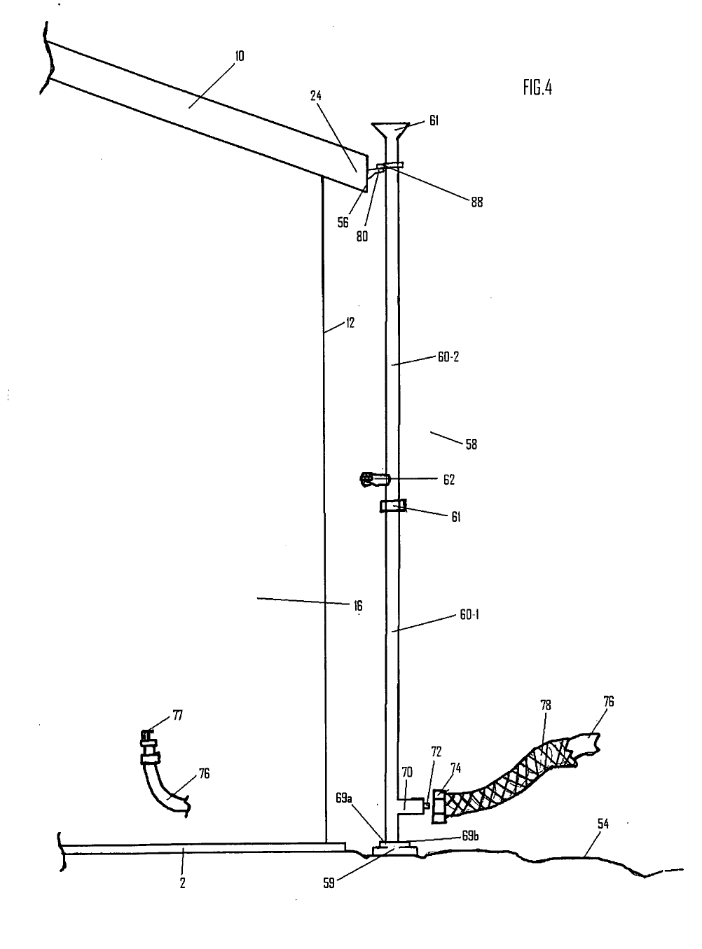

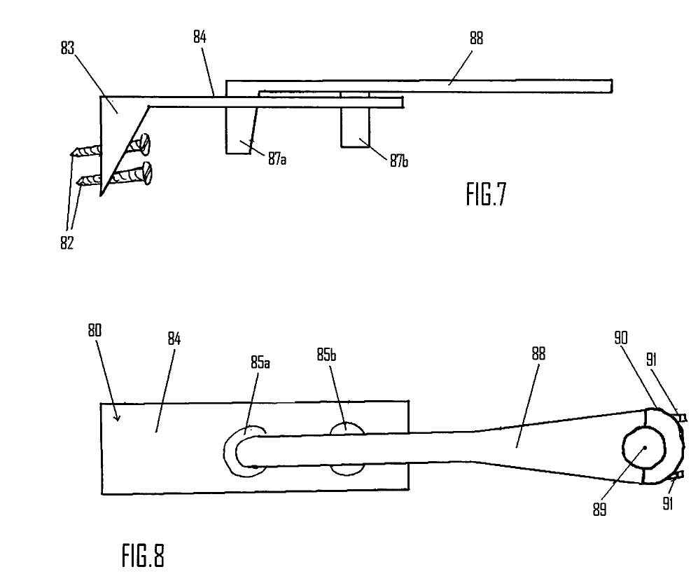

FIG. 3 is a front elevation of the first wing 3 of the house 1 illustrating a first water line 58 secured in a predetermined spacing with respect to the first wall 12. FIG. 4 is a side elevation of the first wing 3. A ground-level 54 is adjacent to a bottom of the first wall 12. Adjacent a top of the first wall 12 is a side surface 56 of the first wall eave 24. Examples of securing means for the first water line 58 are further illustrated with respect to FIGS. 7-9. The water line 58 is supported between the ground-level 54 and the side surface 56 of the first wall eave 24. Additional or alternative support points may be provided. The water line 58 is a conduit with outlets. Many different materials may be used as the conduit, depending on desired characteristics. PVC provides for light weight. However, PVC may be less sturdy and more subject to heat damage than metal pipe. A metallic or foil coating may be provided on the PVC to reflect heat. Copper tubing may also be utilized. In one nominal residential application, the water line 58 has a diameter of ¾″.

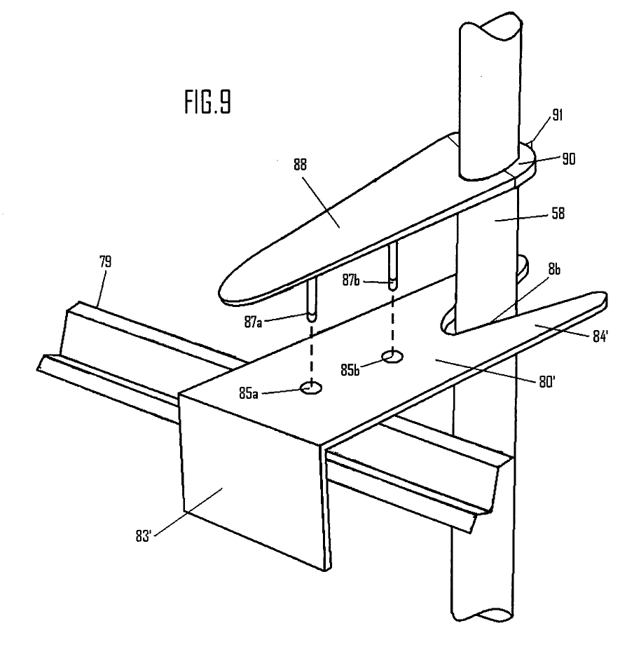

The water line 58 may be provided in the color of the material of which it is made. Alternatively, a water line 58 may be painted or otherwise pigmented, in whole or in part. One aspect of embodiments of the present subject matter is to provide indicia on each water line 58 so that a user 52 may readily associate each water line 58 to a wall to which the water line 58 has been dimensioned. Color coding comprises one form of indicia. For example, each water line 58 can be color coded to match securing means (FIGS. 8 and 9) to which it is to be connected. Other indicia, e.g., numbers, may be used on the first wall 12 of the house 1 to which the water line 58 is to be installed.

The water line 58 has an inlet 70 at a lower end thereof coupled by a hose 76 to a faucet 77. The faucet 77 provides water from the domestic water supply to the house 1. Details of this connection are further discussed below with respect to FIGS. 4 and 6. Alternatively, the hose 76 may provide water pumped from a pond or from a water truck or water tower or other source.

The diameter of each water line 58 should be selected in view of water pressure to be provided to the water line 58 and the output pressure to be provided and rate of flow capacity. A rate of flow capacity should be considered in view of available water sources. The diameter may be selected to match that of the plumbing of the house 1, e.g., ½ inch. It is desirable to consider the pressure and volume that will be provided when water input to the water line 58 is unrestricted by a valve. Larger diameters may provide for a larger capacity. In California, many old houses have ½″ pipe. Most new homes have ¾″ or 1″ pipe.

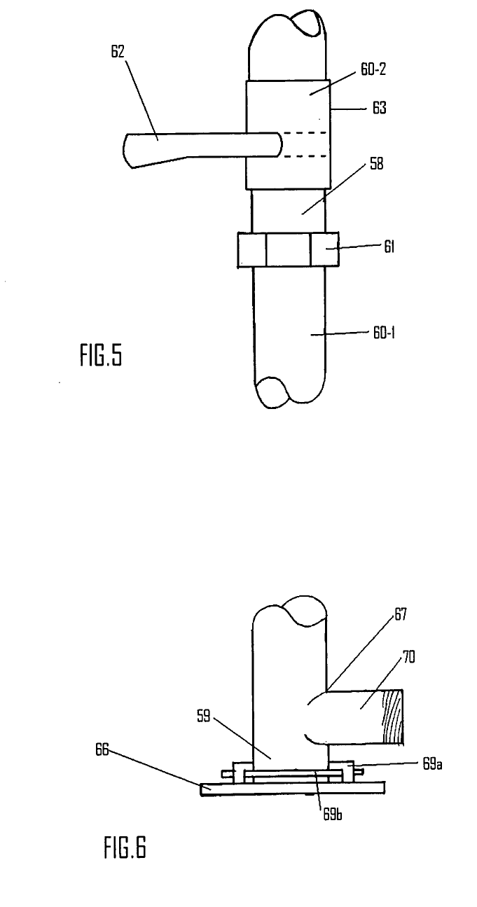

The water line 58 could comprise a single length of pipe. As further seen with respect to FIG. 4 and FIG. 5, the water line 58 may comprise a plurality of sections 60. In the illustration of FIGS. 4 and 5, first and second sections 60-1 and 60-2 are provided and are joined by a section coupler 61. Where more than two sections 60 are used, a plurality of couplers 61 may be used. The present illustration comprises couplers 61-1 and 61-2. Conventional couplings may be used. One form of preferred coupler 61 is a wrenchless connector. The wrenchless connector may have a steep thread so that coupling is accomplished in only three turns. O-rings seal the junctions of the connector 61 with sections 60. Alternatively, PVC couplings may comprise a cylinder secured to sections 60-1 and 60-2 by adhesive. Compression fittings may be used in conjunction with copper tubing. Additional couplings 61 and sections 60 may be provided for use in conjunction with walls of different heights. For example, in the present illustration, the first wall 12 is the height of a single story. The third wall 18 will have a height of two stories where a second water line 58-2 will be placed. A single inventory of components may be provided for construction of water lines 58 of different numbers of stories. Components may also be provided to accommodate preselected heights of various walls of split-level houses.

A side sprayer 62 is located on the water line 58 at a location below the first wall eave 24. The sprayer 62 may be supplied from a sprayer tee section 63 interposed in the line 60-2. A threaded coupling or other form of coupling may be used to connect the sprayer 62 and the sprayer tee section 63. Water exiting the side sprayer 62 will cool the first wall 12. Additionally, spray is directed below the first wall eave 24. Many houses burn due to buildup of heat under the eaves. Even in situations in which the walls and roof of a house may not ignite, heat levels under an eave can reach 700° F. This temperature is sufficient to cause ignition even in the absence of flames. Water spray below the first wall eave 24 can reduce temperatures to levels below ignition points of building materials. A spray pattern 64 from the side sprayer 62 may be selected to cover screens on windows and attic vents. In many embodiments, a side sprayer 62 will be provided which provides a fan-shaped spray pattern 64.

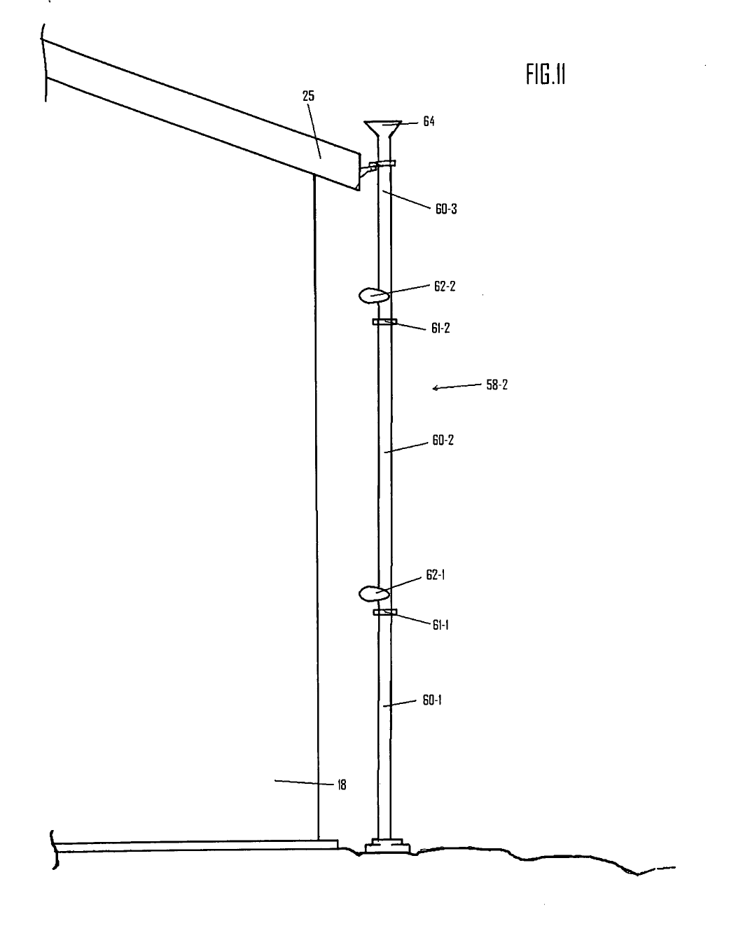

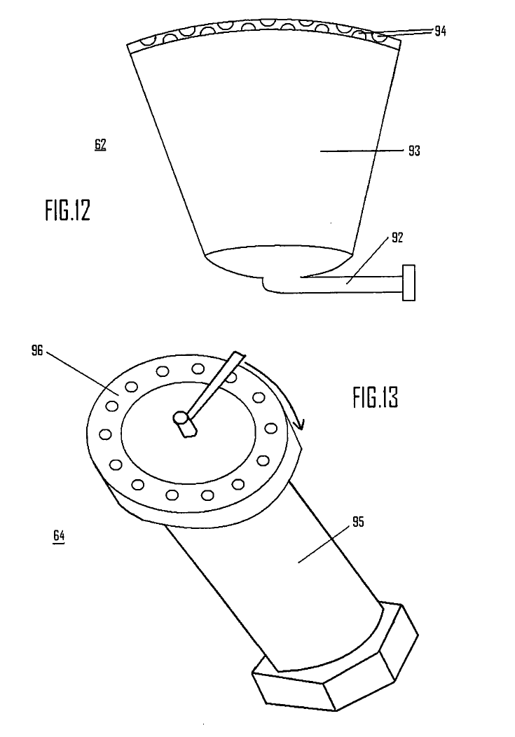

Additionally, a top sprayer 65 may be coupled to a top of the water line 58 to provide cooling on the roof 10. The top sprayer 65 may be selected to provide a spray having 360° coverage. The spray may be aimed so that water reaches sides of the roof 10 that are adjacent the first wall 12 and are adjacent the second wall 14. The side sprayer 62 and top sprayers 64 are discussed further with respect to FIGS. 12 and 13. The terms “top” and “side” are used to denote that sprayers may provide different water patterns. This terminology is not intended to restrict possible constructions of a water line 58.

A base 66 of the water line 58 is seen in FIGS. 4 and 6. The base 66 may comprise a flat member affixed to a closed bottom end 59 of the water line 58. Alternatively, the base 66 may have spikes projecting therefrom for engaging the ground at the ground level 54. Among other forms the base 66 may take is a block including an ell fitting (not shown) for coupling to the water line 58. In the illustrated embodiment, water is connected directly to the water line 58 rather than to the base 60. A retaining wall 69a may be provided extending from the base 66 to surround a portion of the bottom end 59 of the water line 58. The bottom end 59 may be releasably secured within the wall 69a by a removable pin 69b.

The water line 58 has a T section 67 which may comprise a tee fitting 68 including an inlet 70. The inlet 70 comprises a fastening means 72 for coupling the inlet 70 to a water source. In the present illustration, the fastening means 72 comprises a thread which can receive a hose coupling 74 of a hose 76. The hose 76 may include a shielding layer 78 to protect the hose 76 from heat and embers. The T section 67 is employed so that the inlet 70 is displaced from the ground level 54. The inlet 70 may be otherwise displaced from the ground level 54. While convenient, such displacement is not essential.

FIG. 7 is an elevation and FIG. 8 is a plan view of an arrangement for releasably securing the water line 58 to the side surface 56 of the first wall eave 24. A bracket 80 is secured by fastening means 82 to the side surface 56. The bracket 80 may be ell-shaped, having a first leg 83 secured to the side surface 56 and a second leg 84 extending away from the first wall eave 24.

The bracket 80 is releasably secured to a radial arm 88. A second leg 84 of the bracket 80 includes first and second apertures 85a and 85b for receiving first and second locating pins 87a and 87b attached to or unitary with the radial arm 88. Other numbers of pins could be utilized. In one form, the first and second apertures 85a and 85b are circular, and the first and second locating pins 87a and 87b (collectively, and the locating pins 87) are cylindrical. The first and second apertures 85a and 85b may have a larger diameter than the first and second locating pins 87a and 87b, preferably slightly larger. This allows for ease of installation while limiting relative motion of the radial arm with respect to the bracket 80. In one embodiment, the apertures 85a and 85b may have a diameter of ⅜″ while the locating pins 87a and 87b have a diameter of ¼″.

The radial arm 88 is positioned to extend radially from the water line 58. The first and second locating pins 87a and 87b may be spaced along a radial axis 86 of the radial arm 88. When two or more locating pins 87 are provided, the pin arrangement will prevent rotation of the radial arm 88 with respect to the bracket 80. Many other forms of releasable couplings may be provided. Dimensions of the bracket 80 and radial arm 88 will determine the spatial relationship of the water line 58 to the first wall 12.

The first and second locating pins 87a and 87b extend downwardly from the radial arm 88. In one form, the radial arm 88 is positioned vertically to be supported approximately 1″ above the second leg 84. The locating pins 87 may, for example, extend another inch below the second leg 84. The first and second locating pins 87a and 87b in one form have a length sufficient to provide a wide tolerance with respect to the relative heights of the second leg 84 of the bracket 80. More specifically, the first and second locating pins 87a and 87b will engage the first and second apertures 85a and 85b over a range of relative heights of the second leg 84 and the bracket 80. Therefore, even if the ground level 54 changes over time by a value within the range, the second leg 84 and the bracket 80 will still properly be positionable with respect one another.

The radial arm 88 has an arm aperture 89 for surrounding an upper portion of the water line 58. In one preferred form, an end of the radial arm 88 is split along a diameter of the arm aperture 89. An end section 90 is removably secured by fasteners 91 to close the arm aperture 89 around the water pipe 58. This construction permits adjustability of the height of the radial arm 88 on the water line 58. Allowing such an adjustment of the radial arm 88 reduces the need to match the position of the radial arm 88 to the height of the bracket 80. Successive deployments of the system may be separated by years. In that time, the ground level 54 (FIG. 4) may change. Other changes may occur. Adjustability allows a homeowner to forego periodic removal of the system from storage to check measurements.

FIG. 9 is an illustration of the components of the releasable securing means in a detached state including a bracket 80′, which is a further form of the bracket 80. Alternatively, as seen in FIG. 9, the bracket 80′ may have a first leg 83a shaped to engage a gutter 79. The gutter 79 may be supported to the first wall eave 24 (FIG. 4). By connecting the bracket 80′ to the gutter 79, a homeowner need not have the bracket 80 permanently attached to the first wall eave 24. In the present illustration, a first leg 83′ comprises a straight leg which may be received between the gutter 79 and the first wall eave 24. The first leg 83′ may take other forms in order to interact with other gutter configurations. In the present illustration, the bracket 80′ has a perimeter with a trapezoidal envelope in a horizontal plane. A second leg 84′ of the bracket 80′ extends from the first wall eave 24 to a position beyond the water line 58. The bracket 80′ includes a notch 80b to receive the water line 58 within the trapezoidal perimeter of the bracket 80′.

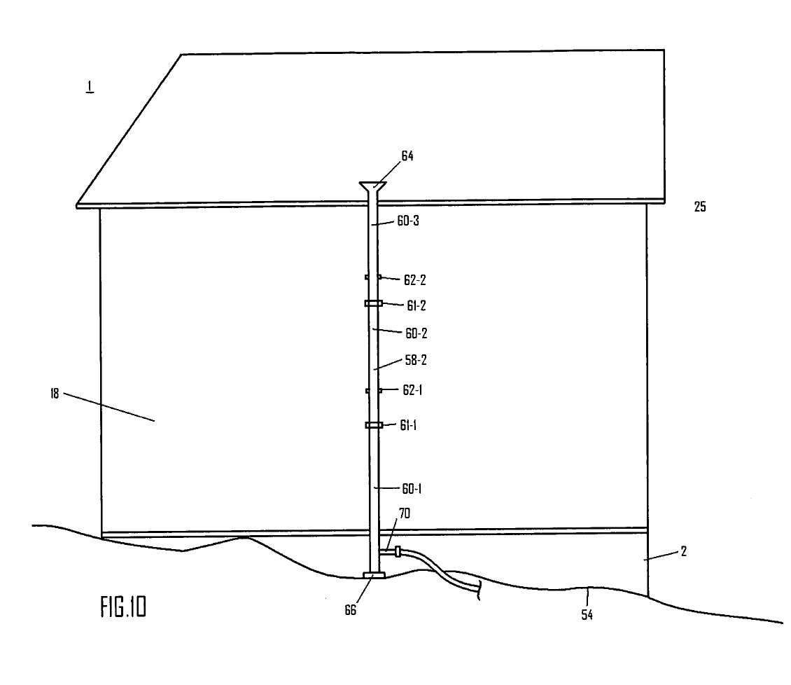

FIGS. 10 and 11 are respectively a front elevation and a side elevation of a second water line 58-2, adjacent the second wall 14. The water line 58-2 includes a plurality of sections 60 coupled to provide for coverage of the two-story wall 14. In a preferred embodiment, the water line 58-2 may extend up to 30 feet. Three 10-foot sections 60 are provided.

FIG. 12 is a plan view of the side sprayer 62. The side sprayer 62 comprises an inlet 92 coupled to the water line 58. Commonly, the inlet 92 is perpendicular to the water line 58. The side sprayer 62 further comprises a head 93 which directs water toward the house 1. The head 93 comprises a plurality of perforations 94 through which water exits. In the present illustration, the head 93 is shaped to provide a fan of water.

FIG. 13 is a perspective view of a top sprayer 65. The top sprayer 65 comprises an inlet 95 which is coaxial with a top end of the water line 58. An outlet 96 may be provided to produce a spray. The outlet 96 could be selected to provide other spray patterns. In one preferred form, the outlet 96 comprises an impact sprinkler. An impact sprinkler rotates around an axis of the water pipe 58, stepping in discrete angular increments. The impact sprinkler in one form will be set to rotate 360°. Lesser ranges of rotation could be used. A substantially fan-shaped spray is projected in a radial direction. An example of an impact sprinkler is the Rainbird sprinkler. The outlet 96 could alternatively comprise other forms of sprinklers or a static component with apertures.

Embodiments of the present subject matter provide a system which need not be permanently installed. Expense in installation is avoided. Because the components may be stored, they are protected from weathering. Consequently, required inspection and maintenance is minimized. Clogging of sprayers due to particulate matter in the air or corrosion is also minimized. Aesthetic impact on the appearance of a structure is minimized.

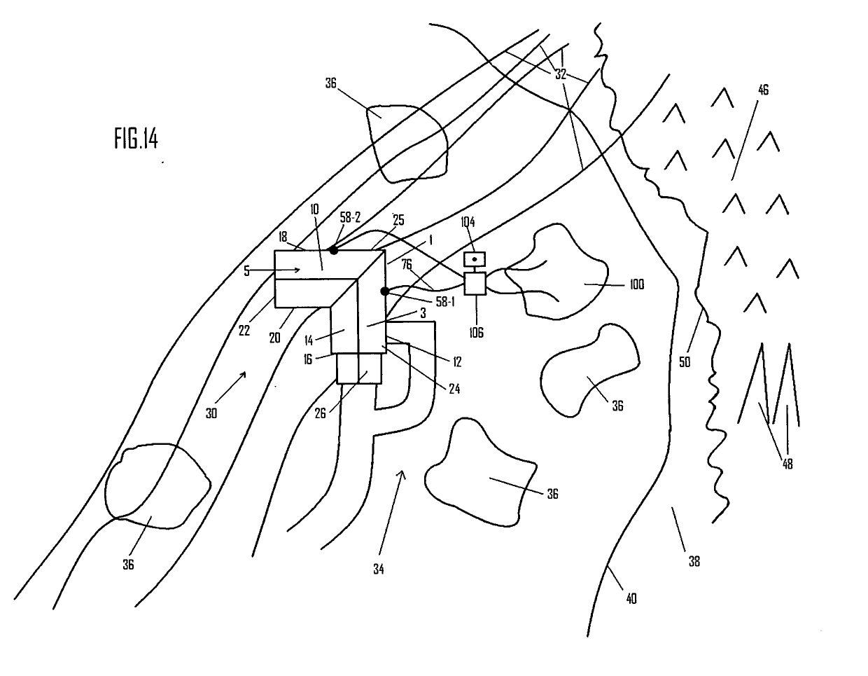

FIG. 14 is a plan view of a system comprising a further embodiment. In the present illustration, the lot 34 has a water supply 100 to which a plurality of input hoses 102 are connected. The water supply 100 may be a pond, for example. A generator 104 may be coupled to a pump 106. A plurality of the hoses 76 are connected to an output. It is desirable in one embodiment in which to provide water pressure approximating household water pressure. This may be achieved by limiting pumping of water to 8-10 gallons per minute per water line 58. Pressure does not drop so long as pumping capacity is not exceeded. The pump 106 and the water lines 58 are proportioned such that a plurality of water lines may be connected to said pump while maintaining rated pump volume and pressure.

### EXAMPLE

In one deployment of an embodiment of the present subject matter, a homeowner was able to remove the system from storage and deploy it readily. The present system is more easily handled than prior art systems (and also less expensive). Two water lines 58 were operated for seven hours and used approximately 1200 gallons of water. The sprayers maintained the house below ignition temperature while houses immediately surrounding the subject house burned to the ground. Deployment of the water line 58 was undertaken as flames were approaching the house. The user 52 went to a storage area and carried water lines 58-1 and 58-2 to the house 1. Each water line 58 was color-coded to the proper corresponding bracket 80. Each water line 58 was lifted. The user 52 hooked each radial arm 88 into its corresponding bracket 80. No adjustments were required in the heights of the water lines 58 because they were preset to the proper dimensions for each wall.

Water spraying began as the flames were approaching the house 1 from east to west. Flames up to 30 feet high came within 20 feet of the house. As the flames approach the house 1, heat built up. The water kept the walls 12 and 18 cool. The user 52 did not have to be at the side of the house 1 which was facing the flames. The flames consumed the surrounding brush and continued on past the house 1. The house remained unscathed after the fire had passed.

A chicken coop on the same lot as the house burned. Seven homes within ¼ mile of the house were consumed by fire. Another seven homes within one mile of the house were also destroyed.

The previous description of some aspects is provided to enable any person skilled in the art to make or use the present subject matter. Various modifications to these aspects will be readily apparent to those skilled in the art, and the generic principles defined herein may be applied to other aspects without departing from the spirit or scope of the subject matter. For example, one or more elements can be rearranged and/or combined, or additional elements may be added. Thus, the present subject matter is not intended to be limited to the aspects shown herein but is to be accorded the widest scope consistent with the principles and novel features disclosed herein.

What is claimed is:

1. A releasably engageable fire suppression system for a building having walls and a roof for maintaining a preselected building wall below an ignition temperature, said system comprising: a portable water line; said water line including an inlet and at least one outlet; an arm for releasably securing said water line to the preselected wall, said at least one outlet being positioned on said water line to direct water to provide a preselected patterns output toward the wall.

2. A fire suppression system according to claim 1, wherein said water line comprises a plurality of sections and a connector connecting each said section to a next section.

3. A fire suppression system according to claim 2, wherein said water line has an inlet adjacent a lower end thereof and an upper outlet at an upper end thereof.

4. A fire suppression system according to claim 2, wherein said water line comprises an intermediate outlet positioned to direct water under eaves at an upper end of the preselected wall.

5. A fire suppression system according to claim 3, wherein said water line comprises an outlet positioned to direct water under eaves at an upper end of the preselected wall.

6. A fire suppression system according to claim 5, wherein said upper outlet comprises an impact sprinkler.

7. A fire suppression system according to claim 6, wherein said impact sprinkler is set to rotate through a predetermined angular displacement.

8. A fire suppression system according to claim 5, wherein said intermediate outlet comprises a sprayer.

9. A fire suppression system according to claim 6, wherein said water line comprises a substantially rigid pipe.

10. A fire suppression system according to claim 2, further comprising a bracket for securing to the house and for coupling to said arm.

11. A fire suppression system according to claim 2, wherein said water line bears indicia associated uniquely with one of the walls.

12. A fire suppression system according to claim 11, further comprising indicia for each said at least one wall of the building.

13. A fire suppression system according to claim 11, wherein said indicia for each said at least one wall of the building is comprised in said bracket.

14. A fire suppression system according to claim 11, wherein said indicia comprises color.

15. A fire suppression system according to claim 5, further comprising a hose for coupling said inlet to a water source.

16. A fire suppression system according to claim 5, wherein said house further comprises shielding.

17. A fire suppression system according to claim 5, comprising a plurality of water lines each associated with one preselected wall of said building.

18. A fire suppression system according to claim 5, further comprising a pump to pump water from a source to said water lines.

19. A fire suppression system according to claim 18, wherein said pump and said water lines are proportioned such that a plurality of water lines may be connected to said pump while maintaining rated pump volume and pressure.
